(19) United States
(12) Patent Application Publication
(10) Pub. No.: US 2025/0033592 A1
(43) Pub. Date: Jan. 30, 2025

(54) VEHICLE AND AIRBAG DEVICE

(71) Applicant: MAZDA MOTOR CORPORATION, Hiroshima (JP)

(72) Inventor: Shinji OKADA, Aki-gun (JP)

(73) Assignee: MAZDA MOTOR CORPORATION, Hiroshima (JP)

(21) Appl. No.: 18/772,630

(22) Filed: Jul. 15, 2024

(30) Foreign Application Priority Data
Jul. 25, 2023 (JP) 2023-120601

(51) Int. Cl. B60R 21/231; B60R 21/00; B60R 21/2338

(52) U.S. Cl. CPC B60R 21/23138; B60R 21/2338; B60R 2021/0058

(57) ABSTRACT

A vehicle and an airbag device provide protection to an occupant even in a case where an oblique collision load is input from the front. The vehicle includes a vehicle seat, a door which is arranged adjacently to the vehicle seat on a vehicle-width-direction outer side, and an airbag device including an airbag which expands and is deployed between the occupant seated in the vehicle seat and the door when a front oblique collision load is input. The airbag includes an abdomen expansion portion which expands and is deployed to surround a region from a vehicle-width-direction outer side portion to part of a front-side portion of an abdomen of the occupant when an oblique left front collision load is input.

### TECHNICAL FIELD

The present disclosure relates to a vehicle and an airbag device.

### BACKGROUND

In order to provide protection of an occupant in a vehicle collision, an airbag device is mounted on a vehicle. In a vehicle disclosed in Japanese Patent Laid-Open No. 2018-135016, a side airbag device is built in a seat back of a front seat and is configured to expand and to be deployed to a side area of a portion from a head to an upper arm of an occupant between a seat and a door in a vehicle collision.

Further, Japanese Patent Laid-Open No. 2008-201297 discloses a large-sized side airbag device which protects a chest and a lower back of an occupant in a vehicle collision. The side airbag device disclosed in Japanese Patent Laid-Open No. 2008-201297 includes a strap having one end fixed to a front end upper portion of an airbag, and the other end fixed to a front end lower portion. The strap is routed in internal portions of a seat cushion and a seat back and is wound around a coupling rod and a reclining rod.

### SUMMARY

However, in the above related art, there are cases where protection of an occupant is not sufficiently provided in a case where a collision load is input from oblique front. Specifically, in a case where the collision load is input from obliquely left front, an occupant is moved obliquely leftward forward. In this case, a case is possible where the occupant seated on a left side of a vehicle collides with an obliquely left front portion of a door trim, an obliquely left front pillar, or the like.

Further, in a case where conversely, the collision load is input from obliquely right front, the occupant is moved obliquely rightward forward. In this case, a case is possible where the occupant seated on a right side of the vehicle collides with an obliquely right front portion of the door trim, an obliquely right front pillar, or the like. It is demanded that protection of the occupant be certainly performed in a case where such a collision load from the oblique front is input.

The present disclosure has been made for solving the above problems and providing a vehicle and an airbag device that can provide protection of an occupant even in a case where a collision load is input from oblique front.

A vehicle according to one aspect of the present disclosure includes: a vehicle seat; a door which is arranged adjacently to the vehicle seat on a vehicle-width-direction outer side; and an airbag device including an airbag which expands and is deployed between an occupant seated on the vehicle seat and the door when a collision load from oblique front is input.

In the vehicle according to this aspect, the airbag includes an abdomen expansion portion which expands and is deployed to be positioned in a region from a vehicle-width-direction outer side portion to a part of a front-side portion of an abdomen of the occupant when the collision load from the oblique front is input.

In the vehicle according to the above aspect, since the airbag in the airbag device includes the abdomen expansion portion, when the collision load from the oblique front is input, the occupant is moved obliquely forward in a state where the abdomen expansion portion is wound around the abdomen. Thus, by the abdomen expansion portion wound around the abdomen of the occupant, the abdomen or a chest of the occupant can be inhibited from receiving a strong impact force due to a collision with a structure (such as a pillar or a door trim) in an obliquely front area. Thus, the vehicle according to the above aspect can provide protection of the occupant even in a case where the collision load is input from the oblique front.

In the vehicle according to the above aspect, the airbag may further include a shoulder expansion portion which expands and is deployed between a shoulder of the occupant on the vehicle-width-direction outer side and the door when the collision load from the oblique front is input. Further, in the vehicle according to the above aspect, the airbag device may further include one inflator which supplies gas to the abdomen expansion portion and the shoulder expansion portion when the collision load from the oblique front is input.

Since the abdomen expansion portion and the shoulder expansion portion can be expanded and deployed by one inflator, the vehicle according to the above aspect can provide reduction in a device size and manufacturing costs as compared to a case where separate inflators are provided for the abdomen expansion portion and the shoulder expansion portion. Further, since the abdomen expansion portion and the shoulder expansion portion are expanded and deployed by one inflator, a deviation or the like in a deployment starting timing is less likely to occur, and the occupant can be protected in a stable state.

In the vehicle according to the above aspect, a supply channel of the gas for the abdomen expansion portion may be formed to pass through the shoulder expansion portion.

Since the supply channel of the gas for the abdomen expansion portion is formed to pass through the shoulder expansion portion, the vehicle according to the above aspect can provide reduction in the device size and manufacturing costs as compared to a case where separate supply channels of the gas are provided for the abdomen expansion portion and the shoulder expansion portion.

In the vehicle according to the above aspect, the airbag may further include a restriction portion which is provided in a portion between the abdomen expansion portion and the shoulder expansion portion in the supply channel of the gas and which restricts a flow of gas from the shoulder expansion portion to the abdomen expansion portion when the collision load from the oblique front is input.

In the vehicle according to the above aspect, since the restriction portion is provided between the abdomen expansion portion and the shoulder expansion portion, a gas flow between the abdomen expansion portion and the shoulder expansion portion is restricted, and expanded shapes of the abdomen expansion portion and the shoulder expansion portion can be made stable. Thus, the vehicle according to the above aspect is advantageous in providing protection of the occupant when the collision load from the oblique front is input.

In the vehicle according to the above aspect, the airbag may further include a tether which regulates forward expansion and being deployed forward when the collision load from the oblique front is input.

In the vehicle according to the above aspect, since the tether is provided which regulates forward expansion and deployment of the abdomen expansion portion, when the abdomen expansion portion expands and is deployed, the abdomen expansion portion can be caused to surround (to be wound around) the abdomen of the occupant.

In the vehicle according to the above aspect, the tether may be joined to a distal end portion on a vehicle-width-direction inner side and a root portion on the vehicle-width-direction outer side in the abdomen expansion portion.

In the vehicle according to the above aspect, since the tether is joined so as to connect together the distal end portion and the root portion in the abdomen expansion portion, in expansion and deployment, the abdomen expansion portion can be caused to certainly surround the abdomen of the occupant.

An airbag device according to one aspect of the present disclosure includes: an airbag which expands and is deployed between an occupant seated on a vehicle seat and a door arranged adjacently to the vehicle seat on a vehicle-width-direction outer side, when a collision load from oblique front is input; and an inflator which supplies gas to the airbag when the collision load from the oblique front is input. In the airbag device according to this aspect, the airbag includes an abdomen expansion portion which expands and is deployed to surround a region from a vehicle-width-direction outer side portion to a part of a front-side portion of an abdomen of the occupant when the collision load from the oblique front is input.

In the airbag device according to the above aspect, since the airbag includes the abdomen expansion portion, when the collision load from the oblique front is input to a vehicle on which the airbag device is mounted, the occupant is moved obliquely forward in a state where the abdomen expansion portion is wound around the abdomen. Thus, by the abdomen expansion portion wound around the abdomen of the occupant, the abdomen or the chest of the occupant can be inhibited from receiving a strong impact force due to the collision with the structure (such as the pillar or the door trim) in the obliquely front area. Thus, the airbag device according to the above aspect can provide protection of the occupant even in a case where the collision load is input from the oblique front to the vehicle.

In the airbag device according to the above aspect, the airbag may further include a shoulder expansion portion which expands and is deployed between a shoulder of the occupant on the vehicle-width-direction outer side and the door when the collision load from the oblique front is input, and the inflator may be one inflator provided in the airbag device and may supply the gas to both of the abdomen expansion portion and the shoulder expansion portion when the collision load from the oblique front is input.

Since the abdomen expansion portion and the shoulder expansion portion can be expanded and deployed by one inflator, the airbag device according to the above aspect can provide reduction in the device size and manufacturing costs as compared to a case where separate inflators are provided for the abdomen expansion portion and the shoulder expansion portion. Further, since the abdomen expansion portion and the shoulder expansion portion are expanded and deployed by one inflator, a deviation or the like in the deployment starting timing is less likely to occur, and the occupant can be protected in a stable state.

In the airbag device according to the above aspect, a supply channel of the gas for the abdomen expansion portion may be formed to pass through the shoulder expansion portion.

Since the supply channel of the gas for the abdomen expansion portion is formed to pass through the shoulder expansion portion, the airbag device according to the above aspect can provide reduction in the device size and manufacturing costs as compared to a case where separate supply channels of the gas are provided for the abdomen expansion portion and the shoulder expansion portion.

In the airbag device according to the above aspect, the airbag may further include a restriction portion which is provided in a portion between the abdomen expansion portion and the shoulder expansion portion in the supply channel of the gas and which restricts a flow of gas from the shoulder expansion portion to the abdomen expansion portion when the collision load from the oblique front is input.

In the airbag device according to the above aspect, since the restriction portion is provided between the abdomen expansion portion and the shoulder expansion portion, the gas flow between the abdomen expansion portion and the shoulder expansion portion is restricted, and the expanded shapes of the abdomen expansion portion and the shoulder expansion portion can be made stable. Thus, the airbag device according to the above aspect is advantageous in providing protection of the occupant in a case where the vehicle receives an input of the collision load from the oblique front.

In the airbag device according to the above aspect, the airbag may further include a tether which regulates forward expansion and deployment of the abdomen expansion portion when the collision load from the oblique front is input.

In the airbag device according to the above aspect, since the tether is provided which regulates forward expansion and deployment of the abdomen expansion portion, when the abdomen expansion portion expands and is deployed, the abdomen expansion portion can be caused to surround (to be wound around) the abdomen of the occupant.

In each of the above aspects, protection of an occupant can be provided even in a case where a collision load is input from oblique front.

### BRIEF DESCRIPTION OF THE DRAWINGS

FIG. 1 is a plan view illustrating a partial configuration of a vehicle front portion according to an embodiment of the present disclosure.

FIG. 2 is a front view illustrating a configuration of a seat belt 15 and its periphery.

FIG. 3 is a side view illustrating an airbag device in an expanded and deployed state.

FIG. 4 is a perspective view illustrating the airbag device in the expanded and deployed state.

FIG. 5 is a plan view illustrating a deployment form of the airbag device with respect to an occupant.

FIG. 6 is a front view illustrating the deployment form of the airbag device with respect to the occupant.

FIG. 7 is a side view illustrating the deployment form of the airbag device with respect to the occupant.

FIG. 8 is a development view illustrating a configuration of the airbag device.

FIG. 9 is a plan view illustrating a vehicle.

FIG. 10 is a schematic diagram illustrating a motion of the occupant in an oblique front collision.

### DETAILED DESCRIPTION

An embodiment of the present disclosure will hereinafter be described with reference to drawings. Note that forms in the following descriptions represent the present disclosure by way of example, and the present disclosure is not at all limited by the following forms except inherent configurations thereof.

Note that in the drawings used in the following descriptions, “FR” denotes a vehicle front area, “RR” denotes a vehicle rear area, “LH” denotes a vehicle left area, “RH” denotes a vehicle right area, “UP” denotes a vehicle upper area, and “LO” denotes a vehicle lower area.

### 1. Front Structure of Vehicle 1

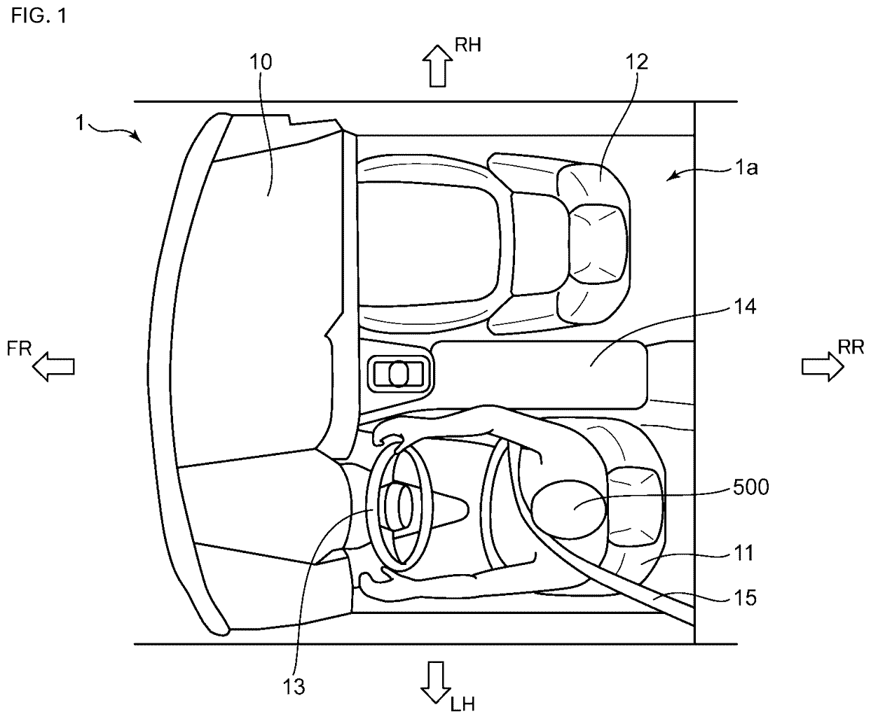

A front structure of a vehicle 1 will be described by using FIG. 1. Note that FIG. 1 illustrates a part of the front structure of the vehicle 1 by extracting only that.

As illustrated in FIG. 1, the vehicle 1 includes an instrument panel 10, which is provided to extend in a vehicle width direction, in a front portion of a vehicle cabin 1a. Vehicle seats 11 and 12 are arranged in the rear of the instrument panel 10 in the vehicle cabin 1a. The vehicle seats 11 and 12 are arranged side by side in the vehicle width direction, and a center console 14 is arranged between those.

A steering wheel 13 is arranged in front of the vehicle seat 11 on a left side. In addition, the vehicle 1 is provided with a seat belt 15 for protecting an occupant 500 when a collision load is input to the vehicle 1. Note that although an illustration is not provided in FIG. 1, a seat belt is disposed for the other vehicle seat in the vehicle 1 so as to be wearable for an occupant.

Note that in the vehicle 1, each of the vehicle seats 11 and 12 is arranged to be slidable in a front-rear direction.

### 2. Wearing Form of Seat Belt 15 and Arrangement Part of Airbag Device 23

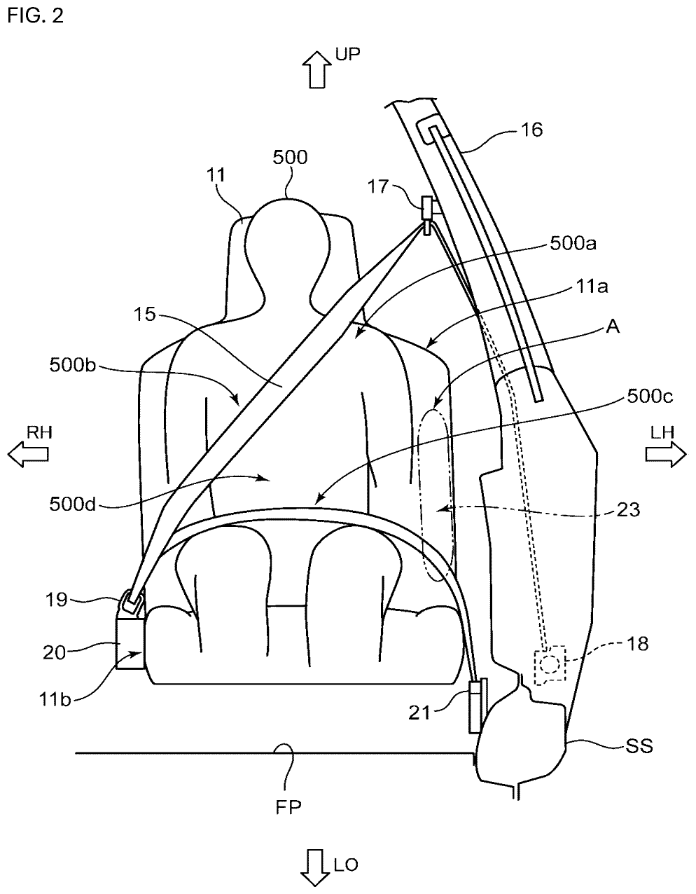

A description will be made by using FIG. 2 about a wearing form of the seat belt 15 and an arrangement part of an airbag device 23. FIG. 2 is a front view in which the occupant 500 seated on the vehicle seat 11 is seen from a front side.

As illustrated in FIG. 2, a retractor 18 which supports the seat belt 15 to be capable of winding that is coupled with one end portion of the seat belt 15. A lap anchor 21 which fixes another end portion to a vehicle body (as one example, a side sill SS on a floor panel FP) is coupled with the other end portion of the seat belt 15.

Further, a tongue 19 which is provided to be slidable along the seat belt 15 is coupled with the seat belt 15. The tongue 19 is lockable to a buckle 20 fixed to a seat cushion 11b of the vehicle seat 11.

Note that a shoulder anchor 17 is mounted on a center pillar 16 of the vehicle 1 in a position above a seat back 11a of the vehicle seat 11. The seat belt 15 is capable of being wound and drawn via the shoulder anchor 17.

In the seat belt 15, a portion which goes from a shoulder 500a on a left side, via a chest 500b, and to a lower back 500c on a right side and a portion which goes from a right side to a left side of the lower back 500c go, with no gap, along the occupant 500 seated on the vehicle seat 11.

Note that the seat belt 15 is configured not to restrain an abdomen 500d of the occupant 500.

In the seat back 11a of the vehicle seat 11, the airbag device 23 is built in a portion A on a vehicle-width-direction outer side. The airbag device 23 is configured to expand and be deployed in a case where lateral acceleration (G) of a predetermined magnitude or greater which is applied to the vehicle 1 is detected.

### 3. Deployment Form of Airbag 230 in Airbag Device 23

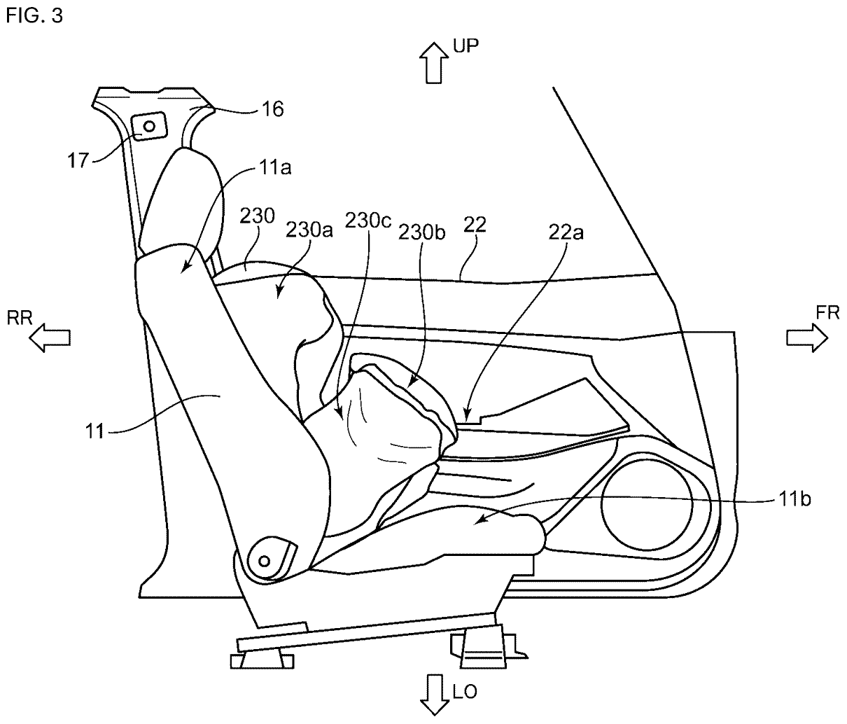

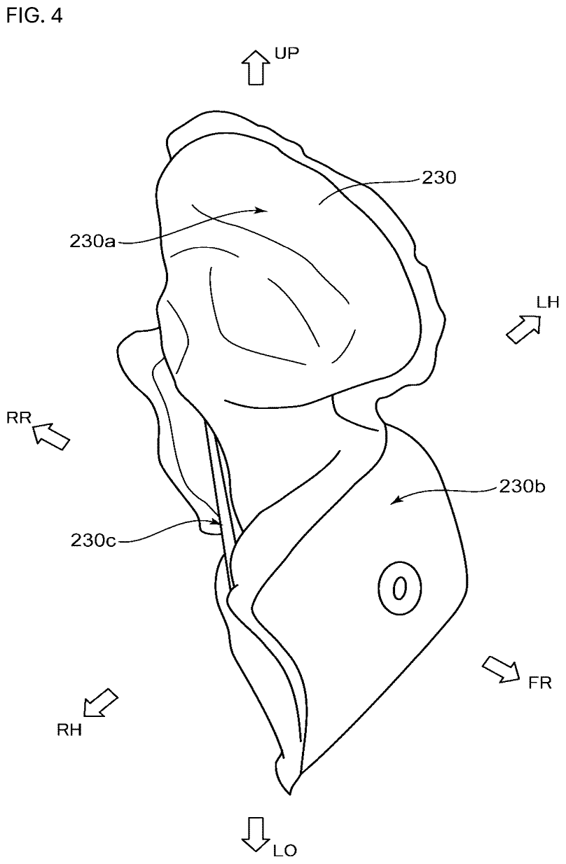

A description will be made by using FIG. 3 and FIG. 4 about a deployment form of an airbag 230 in the airbag device 23.

As illustrated in FIG. 3 and FIG. 4, the airbag 230 in the airbag device 23 includes a shoulder expansion portion 230a which is capable of expanding and being deployed between the seat back 11a of the vehicle seat 11 and a door 22 and an abdomen expansion portion 230b which is capable of expanding and being deployed, in the vehicle width direction, from a lower portion of the seat back 11a of the vehicle seat to a front area of the seat back 11a.

Further, the airbag 230 includes a tether 230c which is joined to a deployment distal end portion and a deployment root portion in the abdomen expansion portion 230b. The tether 230c has a function of regulating forward expansion and deployment of a portion on a distal end portion side of the abdomen expansion portion 230b in expansion and deployment and of attracting rearward a distal end portion of the abdomen expansion portion 230b such that the distal end portion extends to an intermediate portion of the seat back 11a in the vehicle width direction while being spaced forward and apart from the seat back 11a.

As illustrated in FIG. 3, the abdomen expansion portion 230b of the airbag 230 has a portion which extends obliquely upward along the door 22 and extends from a portion close to a lower end of the seat back 11a and a portion which extends inward in the vehicle width direction along the seat back 11a and extends from a vicinity portion of an armrest 22a of the door 22. Such an expansion and deployment posture of the abdomen expansion portion 230b is realized by the tether 230c.

Here, since the airbag device 23 is fixed to the seat back 11a of the vehicle seat 11, even in a case where the vehicle seat 11 is slid and moved in the front-rear direction, a relative positional relationship between the shoulder expansion portion 230a and abdomen expansion portion 230b in expansion and deployment and the vehicle seat 11 is not changed.

4. Deployment Form of Airbag 230 with Respect to Occupant 500

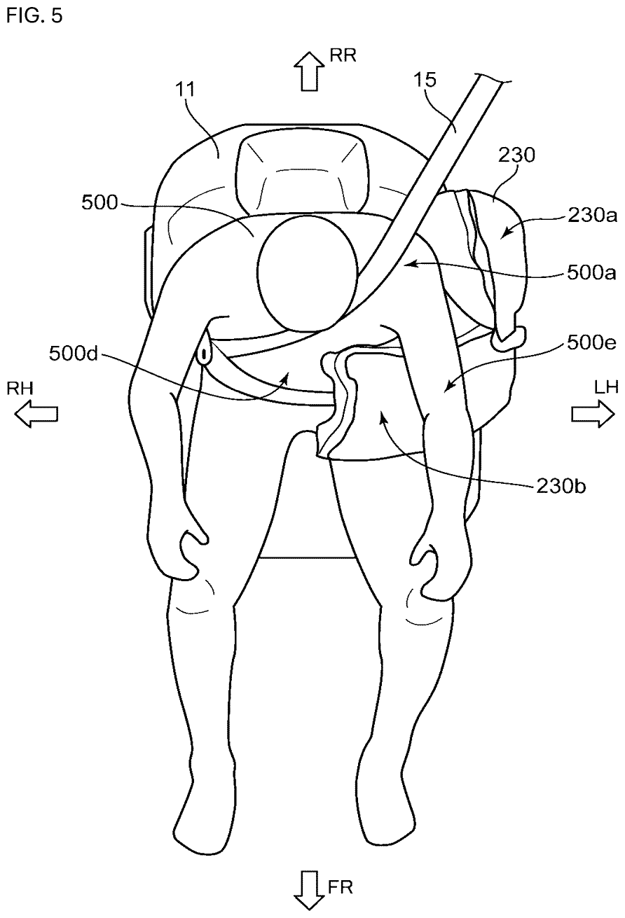

A description will be made by using FIG. 5 to FIG. 7 about a deployment form of the airbag 230 with respect to the occupant 500.

As illustrated in FIG. 5 to FIG. 7, in a case where the lateral acceleration (G) of the predetermined magnitude or greater which is applied to the vehicle 1 is detected, the shoulder expansion portion 230a and the abdomen expansion portion 230b expand and are deployed. The shoulder expansion portion 230a is deployed between the shoulder (a shoulder on an outer side in the vehicle width direction) 500a of the occupant 500 and the door 22 or the center pillar 16.

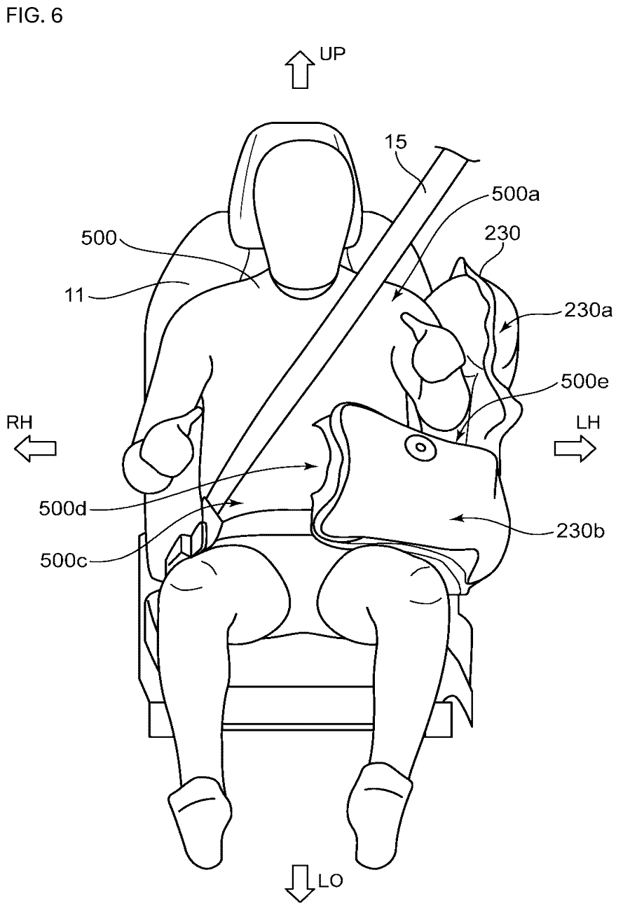

In a case where the lateral acceleration (G) of the predetermined magnitude or greater which is applied to the vehicle 1 is detected, the abdomen expansion portion 230b is deployed so as to surround an outer side abdomen in the abdomen 500d of the occupant 500 to an intermediate portion in the vehicle width direction. As illustrated in FIG. 6, the abdomen expansion portion 230b is deployed on a lower side relative to a portion, which goes from the shoulder 500a to the lower back 500c and extends in an oblique direction, in the seat belt 15. Further, the abdomen expansion portion 230b is deployed on a lower side relative to an arm (an arm on the outer side in the vehicle width direction) 500e of the occupant 500.

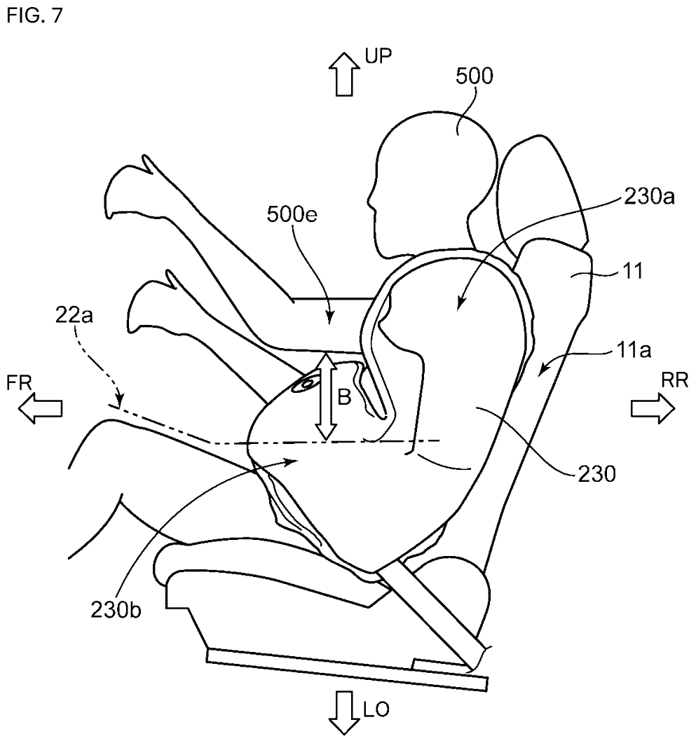

Here, in a state where the collision load is not yet input to the vehicle 1, the occupant 500 seated on the vehicle seat 11 might place the arm 500e on the vehicle-width-direction outer side on the armrest 22a of the door 22. In such a case also, as illustrated in FIG. 7, in a case where the lateral acceleration (G) of the predetermined magnitude or greater which is applied to the vehicle 1 is detected, the abdomen expansion portion 230b which expands and is deployed lifts upward the arm 500e of the occupant 500 and is deployed to go around from a portion B between the armrest 22a and the arm 500e to the front of the abdomen 500d.

### 5. Detailed Structure of Airbag Device 23

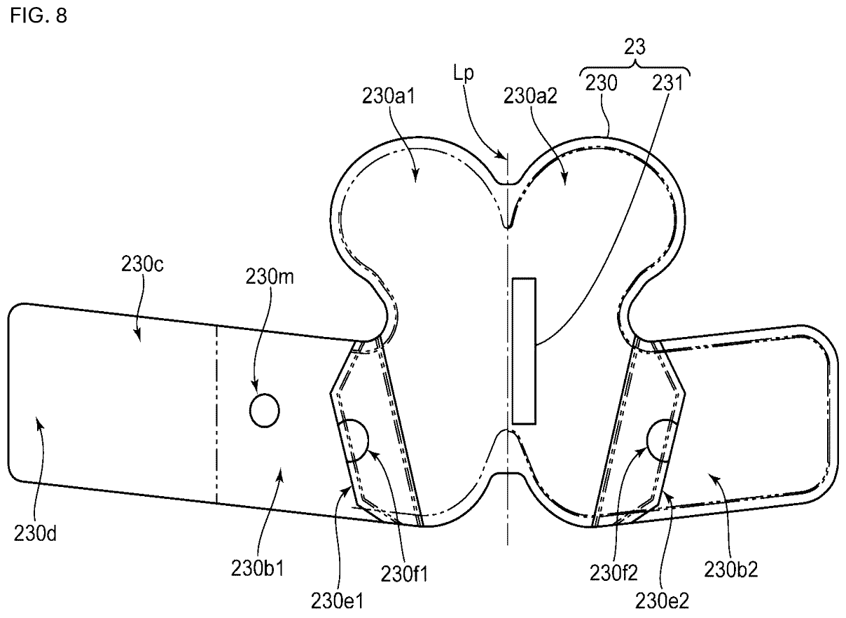

A detailed structure of the airbag device 23 will be described by using FIG. 8. FIG. 8 is a development view illustrating a state where the airbag 230 is deployed in the airbag device 23.

As illustrated in FIG. 8, the airbag device 23 includes the airbag 230 configured with a base fabric and an inflator 231 which supplies gas to the airbag 230 in a case where the lateral acceleration (G) of the predetermined magnitude or greater is detected.

The airbag 230 includes shoulder expansion base fabric portions 230al and 230a2, abdomen expansion base fabric portions 230b1 and 230b2, the tether 230c, and restriction portions 230e1 and 230e2. The shoulder expansion portion 230a (see FIG. 4 and so forth) is configured by folding the base fabric at a folding line Lp and by joining an edge portion of the shoulder expansion base fabric portion 230al to an edge portion of the shoulder expansion base fabric portion 230a2. Note that the inflator 231 is fixed to the vicinity of a folding line Lp in the shoulder expansion base fabric portion 230a2.

The abdomen expansion portion 230b (see FIG. 4 and so forth) is configured by folding the base fabric at the folding line Lp and by joining an edge portion of the abdomen expansion base fabric portion 230b1 to an edge portion of the abdomen expansion base fabric portion 230b2. The tether 230c goes through an outside (rear side) of the abdomen expansion portion 230b and has its rear end portion 230d being joined to a root portion of the abdomen expansion portion 230b.

The restriction portions 230e1 and the restriction portion 230e2 respectively have restriction holes 230f1 and 230f2 which are semicircular holes. The restriction portion 230e1 and the restriction portion 230e are joined to each other such that a generally circular hole is configured with the restriction hole 230f1 and the restriction hole 230f2. Accordingly, between the shoulder expansion portion 230a and the abdomen expansion portion 230b, a gas supply channel is continuous, but a mutual gas flow is restricted. A vent hole 230m is formed in the abdomen expansion base fabric portion 230b1 which corresponds to a counter-occupant side of the abdomen expansion portion 230b, gas is emitted to the outside of the airbag 230, and an expansion degree of the airbag 230 is thereby adjusted.

### 6. Protection of Occupant 500 in Input of Collision Load to Vehicle 1

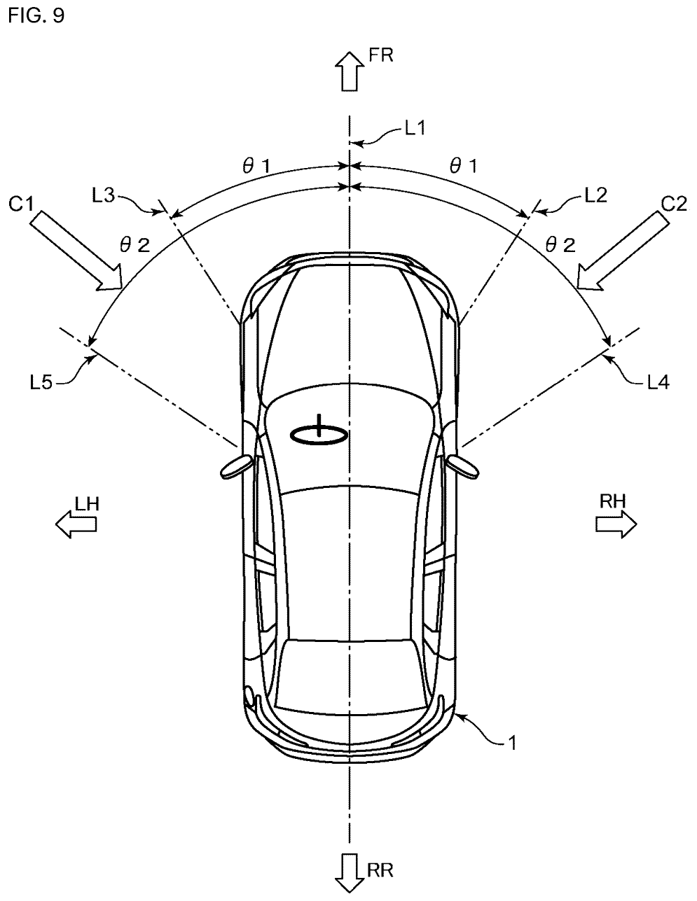

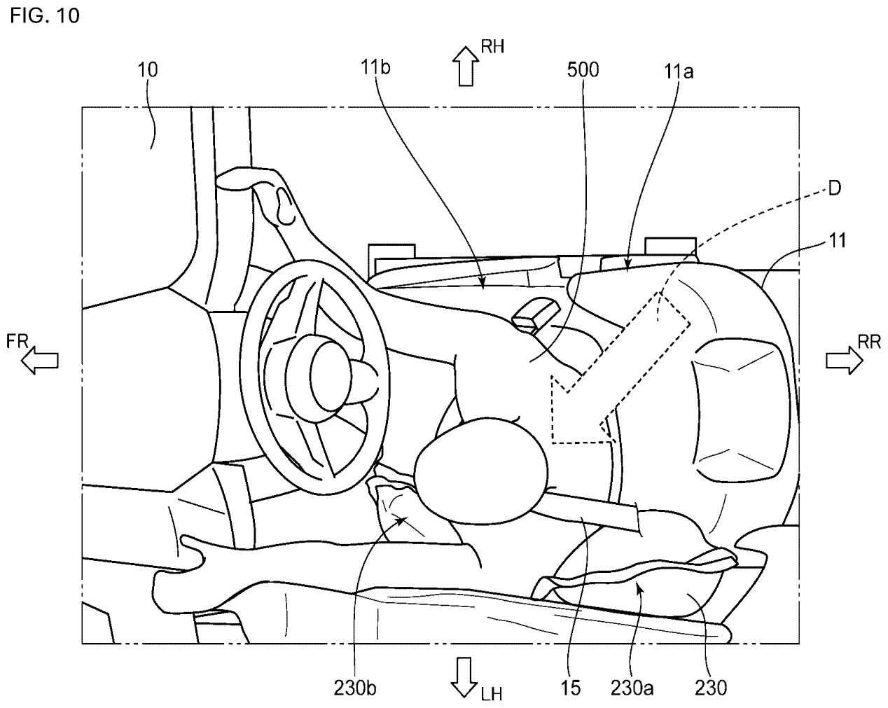

A description will be made by using FIG. 9 and FIG. 10 about protection of the occupant 500 in an input of the collision load to the vehicle 1.

As illustrated in FIG. 9, in the present embodiment, a description will be made while collisions from oblique front as indicated by arrows C1 and C2 are set as a subject. Here, it is assumed that an imaginary line L1 extends in the front-rear direction while passing through a vehicle-width-direction center of the vehicle 1. In this case, as for input directions of the collision loads indicated by the arrows C1 and C2, it is presumed that oblique collision loads are input to the vehicle 1, the oblique collision loads being from regions respectively between imaginary lines L2 and L3 drawn at angles θ1 from the imaginary line L1 and imaginary lines LA and L5 drawn at angles θ2 from the imaginary line L1.

Note that the angle θ1 is larger than 0° and smaller than 30° (for example,) 25°, and the angle θ2 is 30° or larger to 60° or smaller (for example,) 55°.

In a case where the collision load indicated by the arrow C1 is input to the vehicle 1, the occupant 500 riding the vehicle 1 is moved in an opposite direction to the arrow C1. For example, as illustrated in FIG. 10, the occupant 500 seated on the left front vehicle seat 11 is moved obliquely leftward forward as indicated by an arrow D.

In a case where the occupant 500 is moved obliquely forward due to a collision in such a manner, it is possible that the abdomen 500d, the chest 500b, or the like is hit against a front pillar, a door trim, or the like which is present at a movement destination of the occupant 500.

However, in the airbag device 23 included in the vehicle 1 according to the present embodiment, since the airbag 230 includes the abdomen expansion portion 230b in addition to the shoulder expansion portion 230a, the occupant 500 is moved as indicated by the arrow D in a state where the expanded and deployed abdomen expansion portion 230b is wound around the abdomen 500d while the shoulder 500a of the occupant 500 is protected. In this case, since the airbag device 23 is fixed to the seat back 11a, the abdomen expansion portion 230b of the airbag 230 moves together with the occupant 500.

As described above, since the occupant 500 is moved in a state where the abdomen expansion portion 230b is wound around the abdomen 500d when the oblique collision load is input to the vehicle 1, the abdomen 500d, the chest 500b, or the like can be inhibited from receiving a strong impact force due to a collision with the front pillar, the door trim, or the like. Thus, even in an oblique front collision as illustrated in FIG. 9, protection of the occupant 500 can be provided.

Note that although detailed descriptions and illustrations are not made, in the vehicle 1 according to the present embodiment, the airbag device 23 having a similar configuration is also built in the right-side vehicle seat 12 in the front portion of the vehicle cabin 1a. Further, the airbag devices 23 are also built in vehicle seats on both of left and right sides in a rear portion. Accordingly, each occupant 500 in the vehicle cabin 1a of the vehicle 1 can be protected in an oblique collision.

### 7. Effects

In the airbag device 23 according to the present embodiment and the vehicle 1 including the airbag device 23, since the airbag 230 includes the abdomen expansion portion 230b, when the collision load from oblique front (a direction indicated by the arrow C1 or C2 in FIG. 9) is input, the occupant 500 is moved obliquely forward (obliquely leftward forward in the embodiment) in a state where the abdomen expansion portion 230b is wound around the abdomen 500d. Thus, by the abdomen expansion portion 230b wound around the abdomen 500d of the occupant 500, the abdomen 500d or the chest 500b of the occupant 500 can be inhibited from receiving an impact force from a structure (such as a pillar or the door trim) in an obliquely front area. Thus, in the airbag device 23 and the vehicle 1 including the airbag device 23, even in a case where the collision load is input from oblique front, protection of the occupant 500 can be provided.

Further, since the abdomen expansion portion 230b and the shoulder expansion portion 230a can be expanded and deployed by one inflator 231, the airbag device 23 according to the present embodiment and the vehicle 1 including the airbag device 23 can provide reduction in a device size and manufacturing costs as compared to a case where separate inflators are provided for the abdomen expansion portion 230b and the shoulder expansion portion 230a. Further, since the abdomen expansion portion 230b and the shoulder expansion portion 230a are expanded and deployed by one inflator 231, a deviation or the like in a deployment starting timing is less likely to occur, and the occupant 500 can be protected in a stable state.

Further, since the gas supply channel for the abdomen expansion portion 230b of the airbag 230 is formed to pass through the shoulder expansion portion 230a, the airbag device 23 according to the present embodiment and the vehicle 1 including the airbag device 23 can provide reduction in a device size and manufacturing costs as compared to a case where separate gas supply channels are provided for the abdomen expansion portion 230b and the shoulder expansion portion 230a.

Further, in the airbag device 23 according to the present embodiment and the vehicle 1 including the airbag device 23, since the restriction portions 230e1 and 230e2 are provided between the abdomen expansion portion 230b and the shoulder expansion portion 230a of the airbag 230, a gas flow between the abdomen expansion portion 230b and the shoulder expansion portion 230a is restricted, and expanded shapes of the abdomen expansion portion 230b and the shoulder expansion portion 230a can be made stable. Thus, the airbag device 23 and the vehicle 1 including the airbag device 23 are advantageous in providing protection of the occupant when the collision load from oblique front, which is indicated by the arrow C1 or C2 in FIG. 9, is input.

Further, in the airbag device 23 according to the present embodiment and the vehicle 1 including the airbag device 23, since the tether 230c is provided which regulates forward expansion and deployment of the abdomen expansion portion 230b of the airbag 230, when the abdomen expansion portion 230b expands and is deployed, the abdomen expansion portion 230b can be caused to be wound around the abdomen 500d of the occupant 500.

Further, in the airbag device 23 according to the present embodiment and the vehicle 1 including the airbag device 23, since the tether 230c is joined so as to connect together the distal end portion and the root portion in the abdomen expansion portion 230b, in expansion and deployment, the abdomen expansion portion 230b surrounds the abdomen 500d of the occupant 500, and this is advantageous in inhibiting the occupant 500 from moving obliquely forward.

As described above, the airbag device 23 according to the present embodiment and the vehicle 1 including the airbag device 23 can provide protection of the occupant 500 even in a case where the collision load is input from oblique front (for example, the direction indicated by the arrow C1 or C2 in FIG. 9).

### [Modifications]

In the above embodiment, the airbag 230 of the airbag device 23 includes the shoulder expansion portion 230a and the abdomen expansion portion 230b, but according to the present disclosure, an airbag having at least the abdomen expansion portion can be employed. That is, the shoulder expansion portion does not necessarily have to be integrally provided with the abdomen expansion portion.

Further, in the above embodiment, gas supply is possible from one inflator 231 to the shoulder expansion portion 230a and the abdomen expansion portion 230b, but according to the present disclosure, inflators may respectively be provided for the shoulder expansion portion and the abdomen expansion portion. Note that in this case, a gas supply channel for the shoulder expansion portion does not have to pass through the abdomen expansion portion, and stable expanded shapes can be realized regardless of sizes of both of the shoulder expansion portion and the abdomen expansion portion.

In the above embodiment, the airbag 230 includes the restriction portions 230e1 and 230e2, but according to the present disclosure, the airbag does not necessarily have to include the restriction portion.

In the above embodiment, in the airbag 230, the tether 230c is arranged on the outside of the abdomen expansion portion 230b, but the tether may be provided in an inner space of the abdomen expansion portion. That is, as long as in expansion and deployment, the abdomen expansion portion is attracted to be wound around the abdomen of the occupant, a form of the tether is not limited to that of the above embodiment.

What is claimed is:

1. A vehicle comprising:
a vehicle seat;
a door which is arranged adjacently to the vehicle seat on a vehicle-width-direction outer side; and
an airbag device including an airbag which expands and is deployed between an occupant seated on the vehicle seat and the door when a collision load from an oblique front is input, wherein
the airbag includes an abdomen expansion portion which expands and is deployed to be positioned in a region from a vehicle-width-direction outer side portion to a part of a front-side portion of an abdomen of the occupant when the collision load from the oblique front is input.

2. The vehicle according to claim 1, wherein
the airbag further includes a shoulder expansion portion which expands and is deployed between a shoulder of the occupant on the vehicle-width-direction outer side and the door when the collision load from the oblique front is input, and
the airbag device further includes one inflator which supplies gas to the abdomen expansion portion and the shoulder expansion portion when the collision load from the oblique front is input.

3. The vehicle according to claim 2, wherein
a supply channel of the gas for the abdomen expansion portion is formed to pass through the shoulder expansion portion.

4. The vehicle according to claim 3, wherein
the airbag further includes a restriction portion which is provided in a portion between the abdomen expansion portion and the shoulder expansion portion in the supply channel of the gas and which restricts a flow of gas from the shoulder expansion portion to the abdomen expansion portion when the collision load from the oblique front is input.

5. The vehicle according to claim 1, wherein
the airbag further includes a tether which regulates forward expansion and deployment of the abdomen expansion portion when the collision load from the oblique front is input.

6. The vehicle according to claim 2, wherein
the airbag further includes a tether which regulates forward expansion and deployment of the abdomen expansion portion when the collision load from the oblique front is input.

7. The vehicle according to claim 3, wherein
the airbag further includes a tether which regulates forward expansion and deployment of the abdomen expansion portion when the collision load from the oblique front is input.

8. The vehicle according to claim 4, wherein
the airbag further includes a tether which regulates forward expansion and deployment of the abdomen expansion portion when the collision load from the oblique front is input.

9. The vehicle according to claim 5, wherein
the tether is joined to a distal end portion on a vehicle-width-direction inner side and a root portion on the vehicle-width-direction outer side in the abdomen expansion portion.

10. The vehicle according to claim 6, wherein
the tether is joined to a distal end portion on a vehicle-width-direction inner side and a root portion on the vehicle-width-direction outer side in the abdomen expansion portion.

11. The vehicle according to claim 7, wherein
the tether is joined to a distal end portion on a vehicle-width-direction inner side and a root portion on the vehicle-width-direction outer side in the abdomen expansion portion.

12. The vehicle according to claim 8, wherein
the tether is joined to a distal end portion on a vehicle-width-direction inner side and a root portion on the vehicle-width-direction outer side in the abdomen expansion portion.

13. An airbag device comprising:
an airbag which expands and is deployed between an occupant seated on a vehicle seat and a door arranged adjacently to the vehicle seat on a vehicle-width-direction outer side, when a collision load from an oblique front is input; and
an inflator which supplies gas to the airbag when the collision load from the oblique front is input, wherein
the airbag includes an abdomen expansion portion which expands and is deployed to surround a region from a vehicle-width-direction outer side portion to a part of a front-side portion of an abdomen of the occupant when the collision load from the oblique front is input.

14. The airbag device according to claim 13, wherein
the airbag further includes a shoulder expansion portion which expands and is deployed between a shoulder of the occupant on the vehicle-width-direction outer side and the door when the collision load from the oblique front is input, and
the inflator is one inflator provided in the airbag device and supplies the gas to both of the abdomen expansion portion and the shoulder expansion portion when the collision load from the oblique front is input.

15. The airbag device according to claim 14, wherein
a supply channel of the gas for the abdomen expansion portion is formed to pass through the shoulder expansion portion.

16. The airbag device according to claim 15, wherein
the airbag further includes a restriction portion which is provided in a portion between the abdomen expansion portion and the shoulder expansion portion in the supply channel of the gas and which restricts a flow of gas from the shoulder expansion portion to the abdomen expansion portion when the collision load from the oblique front is input.

17. The airbag device according to claim 13, wherein
the airbag further includes a tether which regulates forward expansion and deployment of the abdomen expansion portion when the collision load from the oblique front is input.

18. The airbag device according to claim 14, wherein
the airbag further includes a tether which regulates forward expansion and deployment of the abdomen expansion portion when the collision load from the oblique front is input.

19. The airbag device according to claim 15, wherein
the airbag further includes a tether which regulates forward expansion and deployment of the abdomen expansion portion when the collision load from the oblique front is input.

20. The airbag device according to claim 16, wherein
the airbag further includes a tether which regulates forward expansion and deployment of the abdomen expansion portion when the collision load from the oblique front is input.
